(19) United States
(12) Patent Application Publication
(10) Pub. No.: US 2008/0119581 A1
(43) Pub. Date: May 22, 2008

(54) Material for Metallic-Pattern Formation, Crosslinking Monomer, and Method of Forming Metallic Pattern

(75) Inventors: Hiroshi Takanashi, Kanagawa (JP); Syozo Miyazawa, Kanagawa (JP); Tomoya Kudo, Kanagawa (JP)

Correspondence Address: THELEN REID BROWN RAYSMAN & STEINER LLP, P. O. BOX 640640, SAN JOSE, CA, 95164-0640, US

(73) Assignee: Tokyo Ohka Kogyo Co., Ltd., Kanagawa (JP)

(21) Appl. No.: 11/883,063

(22) PCT Filed: Dec. 28, 2005
(86) PCT No.: PCT/JP05/24140

§ 371 Date: Jul. 25, 2007

(30) Foreign Application Priority Data
Jan. 27, 2005 (JP) 2005-020280

(51) Int. Cl. C08F 2/46; D06M 15/277

(52) U.S. Cl. 522/66; 524/544

(57) ABSTRACT

The present invention provides a process for forming a metal pattern in which a metal is chemically absorbed, and a pattern forming material and a crosslinkable monomer used for the process. The process includes: a step for forming a pattern by photolithography including an exposure step for carrying out exposure with a purified water-based developer having a pH of less than 7 on a pattern forming material containing (A) a matrix polymer having at least one of a carboxyl and a sulfonate group, and a rinsing step; a step for forming a metal-containing pattern by immersing the pattern in an aqueous solution containing a metal compound to allow for chemical absorption of a metal ion or a complex ion to the pattern; and a step for forming a metal pattern containing the elemental metal or further containing metal oxide by sintering the metal-containing pattern. A crosslinkable monomer containing a condensation product of a polyhydric alcohol with N-methylol(meth)acrylamide was used.

### TECHNICAL FIELD

The present invention relates to a process for forming a metal pattern applicable to the production of various electronic devices including flat panel displays such as a field emission display (hereinafter, referred to as an FED), a plasma display as well as others, and a liquid crystal display and to a metal pattern forming material (hereinafter also referred to as a pattern forming material) used for the process.

The present invention also relates to a crosslinkable monomer used in the metal pattern forming material.

### BACKGROUND ART

As a conventional art for forming a metal pattern, a process for forming the metal pattern in which a resin pattern formed on a surface of a substrate is immersed in a solution containing a metal component to absorb the metal component chemically, which is then sintered to form a metal pattern has been known (for example, see Patent Document 1). This patent application discloses a process in which development is carried out by coating a photosensitive resin and exposing thereon followed by development using water or a developer containing more than 50 mass % of water, most preferably water, and water-soluble photosensitive resins exemplified include polyvinyl alcohol and polyvinyl pyrrolidone-based polymers having a carboxyl group, and methacrylic acid-ethyl acrylate-n-butyl acrylate-azobisisobutylonitrile copolymer is used in the Examples.

### Patent Document 1: Japanese Unexamined Patent Application No. 2004-115824 (page 6)

### DISCLOSURE OF THE INVENTION

### Problems to be Solved by the Invention

However, according to the conventional process for forming a metal pattern described above the absorption ability of metal component is so poor that the metal pattern obtained by the sintering has low density.

An object of the present invention is to provide a process for forming a metal pattern using a pattern having high metal absorption ability, and a pattern forming material and a crosslinkable monomer used for the process to form the metal pattern with higher density.

### Means for Solving the Problems

The first aspect of the present invention provides a crosslinkable monomer used for forming a metal pattern material including a condensation product of a polyhydric alcohol with N-methylol(meth)acrylamide.

The second aspect of the present invention provides the crosslinkable monomer according to the first aspect of the present invention, wherein the polyhydric alcohol is pentaerythritol.

The third aspect of the present invention provides provided the crosslinkable monomer according to the first or the second aspect of the present invention, wherein the condensation product is a mixture of mono-condensate in which one molecule of the N-methylol(meth)acrylamide is condensed with one molecule of the pentaerythritol, di-condensate, tri-condensate, tetra-condensate, penta-condensate and hexa-condensate with respect to the pentaerythritol.

The fourth aspect of the present invention provides the crosslinkable monomer according to any one of the first to the third aspects of the present invention obtained by the dehydration reaction of the N-methylol(meth)acrylamide with a given amount of the pentaerythritol added thereto in the presence of acid catalyst.

The fifth aspect of the present invention provides the crosslinkable monomer according to any one of the first to the fourth aspects of the present invention further including a hindered amine-based polymerization inhibitor.

The sixth aspect of the present invention provides a process for forming a metal pattern including: a pattern-forming step for forming a pattern by photolithography including an exposure step for carrying out exposure on a pattern forming material that can be developed with a purified water-based developer having a pH of less than 7 and that has at least one of a carboxyl group and a sulfonate group, and a development step for developing the exposed pattern formation material with the purified water-based developer having a pH of less than 7; a metal-containing pattern-forming step for forming a metal-containing pattern by chemically absorbing a metal ion or a complex ion of a metal compound in an aqueous solution of metal components to the pattern; and a metal pattern-forming step for forming a metal pattern containing at least one of the elemental metal or metal oxide by sintering the metal-containing pattern.

The seventh aspect of the present invention provides the process for forming a metal pattern according to the sixth aspect of the present invention, wherein the pattern forming material can be developed with a purified water-based developer having a pH of 6.5 or less and the exposed pattern formation material is developed with the purified water-based developer having a pH of 6.5 or less in the development step.

The eighth aspect of the present invention provides the process for forming a metal pattern according to the sixth or the seventh aspect of the present invention, wherein the pattern forming material includes (A) a matrix polymer, (B) a crosslinkable monomer and (C) a photopolymerization initiator, and the matrix polymer (A) containing at least one of a carboxyl group and a sulfonate group.

The ninth aspect of the present invention provides the process for forming a metal pattern according to the eighth aspect of the present invention, wherein the acid value of the matrix polymer (A) is from 400 mgKOH/g to 700 mgKOH/g.

The tenth aspect of the present invention provides the process for forming a metal pattern according to the eighth or the ninth aspects of the present invention, wherein the matrix polymer (A) has addition reaction units of the carboxyl group in the main chain and glycidyl methacrylate.

The eleventh aspect of the present invention provides the process for forming a metal pattern according to any one of the eighth to the tenth aspects of the present invention, wherein the crosslinkable monomer (B) includes: (b1) a multifunctional monomer obtained by the condensation of at least a polyhydric alcohol with N-methylol (meta)acrylamide; and (b2) multifunctional (meth)acrylate.

The twelfth aspect of the present invention provides the process for forming a metal pattern according to the eleventh aspect of the present invention, wherein the amount of compounding the multifunctional monomer (b1) is from 10 parts by mass to 50 parts by mass and the amount of compounding the multifunctional (meth)acrylate (b2) is from 5 parts by mass to 23 parts by mass per 100 parts by mass of overall solid content.

The thirteenth aspect of the present invention provides a metal pattern forming material including (A) a matrix polymer, (B) a crosslinkable monomer, and (C) a photopolymerization initiator, in which the matrix polymer (A) containing at least one of a carboxyl group and a sulfonate group.

The fourteenth aspect of the present invention provides the metal pattern forming material according to the thirteenth aspect of the present invention, wherein the crosslinkable monomer (B) includes: (b1) a multifunctional monomer obtained by the condensation of at least a polyhydric alcohol with N-methylol(meth)acrylamide; and (b2) a multifunctional (meth)acrylate, and the pattern forming material can be developed with a purified water-based developer having a pH of less than 7.

According to the first to sixth aspects of the present invention, the use of the copolymer of the polyhydric alcohol and N-methylol(meth)acrylamide as the crosslinkable monomer enables the development with a purified water-based developer having a pH of 6.5 or less.

According to the seventh to the fourteenth aspects of the present invention, chemical absorption of the alkali component in the developer having a pH of more than 7 to the carboxyl group or the sulfonate group in the pattern can be suppressed by the use of the purified water-based developer having a pH of less than 7 as the developer. As a result, in the metal-absorbing step, the absorption of the metal ion or the complex ion of the metal compound to the pattern is facilitated. Also, the metal pattern may be formed stably because the purified water-based developer is used as a developer.

In addition, the introduction of at least either one of a carboxyl group and a sulfonate group into the matrix polymer enables the chemical absorption of the metal ion or the complex ion of the metal compound to the pattern.

Moreover, adjusting the acid value of the matrix polymer from 400 mgKOH/g to 700 mgKOH/g improves the balance between developing performance and resistance to the purified water-based developer used in the pattern-forming step.

### EFFECTS OF THE INVENTION

According to the present invention, chemical absorption of alkali component in the purified water-based developer by the carboxyl group or the sulfonate group in the pattern can be suppressed by the use of the purified water-based developer having a pH of less than 7 as the developer, whereby the chemical absorption of the metal ion or the complex ion of the metal compound to the pattern can be facilitated. Therefore, according to the present invention, a metal pattern with a desired shape, film thickness, and the like can be formed reliably.

According to the conventional process, the metal pattern is formed by the etching of the metal sputtered on the whole surface of the substrate. In contrast, according to the present invention, the metal is selectively absorbed only in the region where the metal pattern is to be formed, by the chemical absorption to the pattern through ionic bonding between at least either one of the carboxyl group or the sulfonate group and the metal ion or the complex ion of the metal compound.

### BRIEF DESCRIPTION OF THE DRAWINGS

FIG. 1 shows the results of the analysis carried out using gel permeation chromatography of the crosslinkable monomer of the present invention.

FIG. 2 shows the results of the mass spectrometric analysis of the crosslinkable monomer of the present invention.

FIG. 3 shows the results of the mass spectrometric analysis of the crosslinkable monomer of the present invention.

### PREFERRED MODE FOR CARRYING OUT THE INVENTION

The process for producing the crosslinkable monomer, the process for forming the metal pattern, and the pattern forming material used therein according to embodiments of the present invention will be illustrated in detail below.

Process for Producing the Crosslinkable Monomer The crosslinkable monomer of the present invention is the condensation product of a polyhydric alcohol with N-methylol(meth)acrylamide.

Examples of the polyhydric alcohol include ethylene glycol, diethylene glycol, 1,2-propanediol, 1,3-propanediol, 1,2-butanediol, 1,3-butanediol, 1,4-butanediol, 2,3-butanediol, 2-butene-1,4-diol, 2-methyl-2,4-pentanediol, 2-ethyl-1,3-hexanediol, 1,2,6-hexanetriol, dipropylene glycol, triethylene glycol, tetraethylene glycol, polyethylene glycol, polypropylene glycol, neopentyl glycol, 1,5-pentanediol, hexanediol, trimethylolpropane, glycerin, diglycerin, polyglycerin, polyoxyethylene (n) diglyceryl ether, polyoxypropylene (n) diglyceryl ether, pentaerythritol, dipentaerythritol, tris(2-hydroxyethyl)isocyanulate, 3-chloro-1,2-propanediol, 2,2′-thiodiethanol, poly(oxyethylene-oxypropylene) derivatives, monosaccharides such as glucose, mannose, galactose and fructose, disaccharides such as sucrose, maltose and lactose, and polysaccharides such as starch, glycogen, dextrin and cellulose, and the like. These may be used alone or in combinations of two or more.

Among them, pentaerythritol is preferably used in view of the improved resistance against the developer after forming the pattern and suppression of precipitation of methylenebis(meth)acrylamide, the reaction product of N-methylol(meth)acrylamide.

Condensation of the aforementioned polyhydric alcohol with N-methylol(meth)acrylamide at a given temperature yields the crosslinkable monomer of the present invention. Condensing for 1.5 hours at 85 to 95° C. is preferred.

The amount of N-methylol(meth)acrylamide added is determined according to the number of hydroxyl groups of the polyhydric alcohol. In the case of pentaerythritol, preferably from 2 to 4 molar equivalents, more preferably from 1.5 to 2.5 molar equivalents of N-methylol(meth)acrylamide is added.

The crosslinkable monomer may further include a polymerization inhibitor. Examples of the polymerization inhibitor include quinone derivatives such as hydroquinone, methyl hydroquinone, hydroquinone monomethyl ether and p-benzoquinone, phenol derivatives such as 2,6-di-tert-butyl-p-cresol, catechol, tert-butylcatechol and pyrogallol, hindered amine-based polymerization inhibitors, and the like. In view of the effect of the inhibitor, the use of the hindered amine-based polymerization inhibitor is preferred. Specific examples of the hindered amine-based polymerization inhibitor include bis(2,2,6,6-tetramethyl-4-piperidyl)sebacate, bis(1,2,2,6,6-pentamethyl-4-piperidyl)sebacate, 4-benzoyloxy-2,2,6,6-tetramethylpiperidine, 8-acetyl-3-dodecyl-7,7,9,9-tetramethyl-1,3,8-triazaspiro[4,5]-decan-2,4-dione, 4-hydroxy-2,2,6,6-tetramethylpiperidine-N-oxyl, 2,2,6,6-tetramethylpiperidine, 2,2,6,6-tetramethylpiperidine-1-oxyl, 2,2,6,6-tetramethyl-4-piperidinol, 2,2,6,6-tetramethyl-4-piperidone, 2,2,6,6-tetramethyl-4-piperidone oxime, 1,2,2,6,6-pentamethylpiperidine, 1,2,2,6,6-pentamethyl-4-piperidone, 2,2,6,6-tetramethyl-4-piperidyl methacrylate, 1,2,2,6,6-pentamethyl-4-piperidyl methacrylate, and the like. The amount of the polymerization inhibitor is preferably in the range of 0.1 to 2 parts by mass per 100 parts by mass of N-methylol(meth)acrylamide.

The solvent used for the condensation reaction may be freely selected from the organic solvents used for the pattern forming material to be described later.

The condensation product obtained from the aforementioned condensation reaction is a mixture of mono-condensate in which one molecule of the N-methylol(meth)acrylamide is condensed with one molecule of the pentaerythritol, di-condensate, tri-condensate, tetra-condensate, penta-condensate and hexa-condensate with respect to the pentaerythritol.

When the condensation product of the present invention is used for the pattern forming material, the amount of compounding thereof is preferably from 20 parts by mass to 80 parts by mass, more preferably from 30 parts by mass to 70 parts by mass per 100 parts by mass of total amount of the entire solid content of the pattern forming material.

### Process for Forming Metal Pattern

The process for forming the metal pattern according to this embodiment is a process for forming a fine metal pattern on the surface of a glass or a ceramic substrate. In particular, the process includes: a pattern-forming step for forming a pattern by photolithography; a metal-containing pattern-forming step for forming a metal-containing pattern by chemically absorbing a metal ion or a complex ion of a metal compound to the pattern; and a metal pattern-forming step for forming a metal pattern containing an elemental metal or further containing metal oxide, by sintering the metal-containing pattern.

The pattern-forming step, specifically, includes a coating step for coating a negative-working pattern forming material that can be developed with a purified water-based developer having a pH of less than 7 on the surface of a substrate; a drying step for drying the coated pattern formation material at a given temperature; an exposure step for carrying out an exposure on the pattern forming material; a development step for developing the exposed pattern formation material with the purified water-based developer; and a water rinsing step for rinsing the pattern with water.

In the pattern forming material, (A) a matrix polymer having at least one of a carboxyl group and a sulfonate group in the composition is used.

The metal-containing pattern-forming step refers to a step in which the pattern obtained as described above is immersed in an aqueous solution containing a metal compound to absorb chemically a metal ion or a complex ion of the metal compound.

The metal pattern-forming step refers to a step in which the metal-containing pattern obtained as described above is washed with water, dried and thereafter sintered to form the metal pattern containing an elemental metal or further containing metal oxide.

The metal pattern to be formed in this embodiment is a pattern containing a noble metal, which is to be formed as a wiring pattern and various electrode patterns.

A photosensitive component containing (A) the matrix polymer having at least one of a carboxyl group and a sulfonate group, and (B) the crosslinkable monomer is used as the pattern forming material. More specifically, the matrix polymer (A) with an acid value in the range from 400 mgKOH/g to 700 mgKOH/g is used for the pattern forming material.

Moreover, in addition to the matrix polymer (A), the crosslinkable monomer (B), and the photopolymerization initiator (C) described above, the composition of the photosensitive component as the pattern forming material according to this embodiment may further contain a thermal polymerization inhibitor, a water-soluble organic solvent with a boiling point of 95 to 180° C. and the like as a coating solution. Also, a plasticizer, an anti oxygen inhibition agent and the like may be added optionally.

### Matrix Polymer

The matrix polymer (A) has double bonds as well as at least one of a carboxyl group and a sulfonate group on the main chain because the metal ion or the complex ion of the metal compound must be left in the pattern after insolubilization through photopolymerization. Of course, the crosslinkable monomer (B), which is a composition other than the matrix polymer (A), may also contain a carboxyl group or a sulfonate group.

Specifically, the matrix polymer (A) may be a copolymer of olefinic unsaturated carboxylic acid and carboxyl salts thereof (i.e., acrylic acid), methacrylic acid, maleic acid, itaconic acid, crotonic acid, 2-acrylamido-2-methylpropanesulfonic acid, tert-butylacrylamidosulfonic acid, styrenesulfonic acid, allylsulfonic acid, methallylsulfonic acid, and the like. The polymer may be one obtained using a monomer component of either the monomer having a carboxyl group or the monomer having a sulfonate group. The polymer may also be one obtained using both monomeric components, the monomers having a carboxyl group and a sulfonate group.

Examples of the monomer which can polymerize with the copolymer of the matrix polymer (A) include acrylate esters, (meth)acrylate esters such as methyl, ethyl, butyl, isobutyl and octyl(meth)acrylate, (meth)acrylate esters having an ether linkage group such as 2-methoxyethyl acrylate and 2-ethoxyethyl acrylate, and monomers containing a hydroxyl group such as 2-hydroxypropyl methacrylate.

Examples of the acrylic amides and methacrylic amides include acrylamide, methacrylamide, dimethyl acrylamide, diethyl acrylamide, dimethylaminopropyl acrylamide, isopropyl acrylamide, and the like.

In addition, other copolymerizable monomers such as styrene, alkyl vinyl ether, vinyl acetate, acrylonitrile, methacrylonitrile, N-vinyl formamide, N-vinyl aceteamide, vinylpyrollidone, and esters of maleic acid, fumaric acid, itaconoic acid and the like may also be used. However, it is indispensable that the produced matrix polymer (A) has an acid value of from 400 mgKOH/g to 700 mgKOH/g, is soluble in water with a pH of 6.5 or less, and is preferably soluble in a water-soluble organic solvent with a boiling point of 95 to 180° C.

In addition, double bonds are preferably introduced in the matrix polymer (A) according to this embodiment to enhance the sensitivity. Specifically, the double bond may be introduced by allowing the carboxyl groups in polyacrylic acid or the copolymer to react with glycidyl methacrylate, an unsaturated epoxy monomer. Also, the double bonds may be introduced by allowing the carboxyl groups in the matrix polymer (A) to react with a methylol group of N-methylol(meth)acrylamide or an alkoxyl group of N-alkoxy(meth)acrylamide.

Examples of the unsaturated epoxy monomer to be reacted with the carboxyl group include glycidyl acrylate, glycidyl methacrylate, allyl glycidyl ether, α-ethylglycidyl ether, crotonyl glycidyl ether, itaconic acid monoalkyl ester monoglycidyl ether, unsaturated compounds containing an alicyclic epoxy group (3,4-epoxycyclohexylmethyl (meth)acrylate), and the like. These may be used alone or in combinations of two or more. The use of such a matrix polymer (A) permits efficient removal of the organic matter by sintering in forming the metal pattern.

### Crosslinkable Monomer

The crosslinkable monomer (B), the other photosensitive component, has at least one polymerizable ethylenic unsaturated group in the molecule. Specific examples of the crosslinkable monomer include monofunctional vinyl monomers, multifunctional vinyl monomers, and the like.

Examples of the monofunctional vinyl monomer include (meth)acrylamide, methylol(meth)acrylamide, methoxymethyl(meth)acrylamide, ethoxymethyl(meth)acrylamide, propoxymethyl(meth)acrylamide, butoxymethoxymethyl(meth)acrylamide, acrylic acid, maleic acid, maleic anhydride, itaconic acid, itaconic anhydride, citraconic acid, citraconic anhydride, crotonic acid, 2-acrylamido-2-methylpropane sulfonic acid, tert-butyl acrylamide sulfonic acid, methyl(meth)acrylate, ethyl (meth)acrylate, butyl(meth)acrylate, 2-ethylhexyl (meth)acrylate, 2-hydroxyethyl(meth)acrylate, 2-hydroxypropyl (meth)acrylate, 2-hydroxybutyl(meth)acrylate, 2-phenoxy-2-hydroxypropyl(meth)acrylate, 2-(meth)acryloyloxy-2-hydroxypropyl phthalate, glycerin mono(meth)acrylate, tetrahydrofurfuryl(meth)acrylate, dimethylamino (meth)acrylate, glycidyl(meth)acrylate, 2,2,2-trifluoroethyl (meth)acrylate, 2,2,3,3-tetrafluoropropyl(meth)acrylate, half (meth)acrylate of phthalic acid derivates, N-methylol(meth)acrylamide, and the like. Above all, the use of acrylic acid, maleic acid, maleic anhydride, itaconic acid, itaconic anhydride, citraconic-acid, citraconic anhydride, crotonic acid, 2-acrylamido-2-methylpropane sulfonic acid or tert-butyl acrylamide sulfonic acid is particularly preferred because of the enhancement of the metal absorption rate.

On the other hand, examples of the multifunctional vinyl monomer includes ethyleneglycol di(meth)acrylate, diethyleneglycol di(meth)acrylate, tetraethyleneglycol di(meth)acrylate, propyleneglycol di(meth)acrylate, polypropyleneglycol di(meth)acrylate, butyleneglycol di(meth)acrylate, neopentylglycol di(meth)acrylate, 1,6-hexaneglycol di(meth)acrylate, trimethylolpropane tri(meth)acrylate, glycerin di(meth)acrylate, pentaerythritol di(meth)acrylate, pentaerythritol tri(meth)acrylate, dipentaerythritol penta(meth)acrylate, 2,2-bis(4-(meth)acryloxydiethoxyphenyl)propane, 2,2-bis(4-(meth)acryloxypolyethoxyphenyl)propane, 2-hydroxy-3-(meth)acryloyloxypropyl (meth)acrylate, ethyleneglycol diglycidyl ether di(meth)acrylate, diethyleneglycol diglycidyl ether di(meth)acrylate, phthalic acid diglycidyl ester di(meth)acrylate, glycerin triacrylate, glycerin polyglycidyl ether poly(meth)acrylate, urethane (meth)acrylate (i.e., the reaction product of tolylenediisocyanate, trimethylhexamethylenediisocyanate, hexamethylenediisocyanate and the like with 2-hydroxyethyl(meth)acrylate), methylene bis(meth)acrylamide, (meth)acrylamide methylene ether, multifunctional monomers such as the condensation products of a polyhydric alcohol with N-methylol(meth)acrylamide, triacrylformal, and the like. As many of the ester-based monomers such as monofunctional vinyl monomers and multifunctional vinyl monomers are lipid-soluble, the use thereof in large amounts is not preferred as the pattern forming material composition of this embodiment. However, they can be used in such an amount in the range not to be left on the substrate.

The multifunctional monomer (b1) obtained by the condensation of polyhydric alcohol and N-methylol(meth)acrylamide is particularly convenient. The polyhydric alcohol that is water-soluble itself is more convenient because of its improved developing performance. Examples of the component (b1) include, e.g., the condensation product of pentaerythritol with N-methylolacrylamide (NMA). Among the combinations of the multifunctional monomer (b1) and multifunctional (meth)acrylate (b2) as another multifunctional monomer, the combination with polyethylene glycol diacrylate exhibited excellent results in the improvement of developing performance. Accordingly, polythylene glycol diacrylate is preferably used as the component (b2).

Particularly, the amount of compounding the multifunctional monomer (b1) and multifunctional (meth)acrylate (b2) is preferably from 10 parts by mass to 50 parts by mass, and 5 parts by mass to 23 parts by mass, respectively, per 100 parts of the overall solid content of the pattern forming material. To improve the developing performance, the amount of compounding the multifunctional monomer (b1) and multifunctional (meth)acrylate (b2) is particularly preferably from 15 parts by mass to 45 parts by mass and 5 parts by mass to 20 parts by mass, respectively.

### Photopolymerization Initiator

Examples of the photopolymerization initiator (C) includes those known in the art, e.g., benzophenone derivatives such as benzophenone, 2,4,6-trimethylbenzophenone, 2-hydroxy-4-alkoxybenzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone and (2-acryloyloxy) (4-benzoylbenzyl)dimethylammonium bromide, benzyl derivatives such as benzoin, benzoin isopropyl ether, benzoin methyl ether, benzoin ethyl ether, benzoin isobutyl ether and benzoin phenyl ether, benzil derivatives such as benzil, dibenzil, benzil diphenyl sulfide and benzil dimethyl ketal, xanthone derivatives such as xanthone, thioxanthone, 2-chlorothioxanthone, 2-methylthioxanthone, 2,4-diethylthioxanthone and 2-(3-dimethylamino-2-hydroxypropoxy)-3,4-dimethyl-9H-thioxanthene-9-one methochloride, acetophenone derivatives such as p-tert-butylacetophenone, 2,2′-diethoxyacetophenone and 2,2′-dichloro-4-phenoxyacetophenone, anthraquinone derivatives such as choloroanthraquinone, 2-methylanthraquinone, 2-ethylanthraquinone, 2-carboxyanthraquinone, sodium anthraquinone-2-sulfonate, sodium anthraquinone-2,6-disulfonate and sodium anthraquinone-2,7-disulfonate, acridine derivatives such as 9-phenylacridine and 1,7-bis(9,9′-acridinyl)heptane, acetophenone, 2,2-diethoxyacetophenone, phenanthrenequinone, 2,4,6-trimethylbenzoyldiphenylphosphine oxide, bis(2,4,6-trimethylbenzoyl)phenylphosphine oxide, bis(2,6-dimethoxybenzoyl)-2,4,4-trimethyl-pentylphosphine oxide, oligo[2-hydroxy-2-methyl-1-[4-(1-methylvinyl)phenyl]propanone], 1-hydroxycyclohexyl phenyl ketone, 2-hydroxy-2-methyl-1-phenyl-1-propan-1-one, 2-methyl-1-[4-(methylthio)phenyl]-2-morpholinopropan-1-one, 1-[4-(2-hydroxyethoxy)phenyl]-2-hydroxy-2-methyl-1-propan-1-one (hereinafter referred to as α-hydroxyketone), 2-benzyl-2-dimethylamino-1-(4-morpholinophenyl)butan-1-one, 1-(O-acetyl oxime)-1-[9-ethyl-6-(2-methylbenzoyl)-9H-carbazole-3-yl]ethanone, and the like. These may be used alone or in combinations of two or more, but not limited to the compounds described herein.

### Amount of Compounding Matrix Polymer

The amount of compounding the matrix polymer (A) in the pattern forming material according to this embodiment is preferably from 20 parts by mass to 80 parts by mass, more preferably from 30 parts by mass to 70 parts by mass per 100 parts by mass of the total amount of the matrix polymer (A), the crosslinkable monomer (B), and the photopolymerization initiator (C).

### Amount of Compounding the Crosslinkable Monomer

The amount of compounding the crosslinkable monomer (B) in the pattern forming material according to this embodiment is preferably from 15 parts by mass to 73 parts by mass, more preferably from 30 parts by mass to 70 parts by mass per 100 parts by mass of the total amount of the matrix polymer (A), the crosslinkable monomer (B), and the photopolymerization initiator (C). When the amount of compounding the crosslinkable monomer (B) exceeds 80 parts by mass, coating property to the substrate deteriorates. Also, the photochemically cured material becomes stiff and fragile and thus sufficient adhesion to the substrate is not achieved. In contrast, when the amount of compounding the crosslinkable monomer (B) is less than 20 parts by mass, the sensitivity may be insufficient.

The crosslinkable monomer (B) is preferably the multifunctional monomer obtained by the condensation of polyhydric alcohol with N-methylol(meth)acrylamide so as to keep the solubility in water at a pH of 6.5 or less, more preferably polyethylene glycol diacrylate to enhance the sensitivity.

Amount of Compounding the Photopolymerization Initiator The amount of compounding the photopolymerization initiator (C) in the pattern forming material according to this embodiment is preferably from 0.05 parts by mass to 10 parts by mass, more preferably from 0.3 parts by mass to 7 parts by mass per 100 parts by mass of the total amount of the matrix polymer (A), the crosslinkable monomer (B), and the photopolymerization initiator (C). When the amount of compounding the photopolymerization initiator (C) is too small, the sensitivity will be insufficient. In contrast, compounding too much photopolymerization initiator (C) will result in deterioration of the resolution of the pattern after the exposure due to the precipitation. When an initiator which forms a light-absorbing compound by the photoreaction is used, light absorption at the surface subjected to the exposure of the photosensitive resist layer increases, which may result in inefficient photo-curing.

The pattern forming material according to this embodiment includes the matrix polymer (A), the crosslinkable monomer (B), and the photopolymerization initiator (C) as major components, and a thermal polymerization initiator; and further, ethyl p-dimethylaminobenzoate, isoamyl p-dimethylaminobenzoate, N,N-dimethylethanolamine, N-methyldiethanolamine, triethanolamine or the like as a photo reaction promoter; a leveling agent; a coloring agent such as a color-fixing agent, a dye or a pigment; a filler; an adhesive agent; a plasticizer and the like may also be added as needed. Each component is not particularly limited and any one known in the art may be used.

### Thermal Polymerization Inhibitor

Thermal polymerization inhibitors known in the art such as, for example, a quinone derivative such as hydroquinone, methyl hydroquinone, hydroquinone monomethyl ether or p-benzoquinone, a phenol derivative such as 2,6-di-tert-butyl-p-cresol, catechol, tert-butylcatechol or pyrogallol, or a hindered amine-based polymerization inhibitor may be used.

### Organic Solvent

The pattern forming material of the present invention may be provided on the substrate by dissolving each component in the organic solvent known in the art, and coating the prepared coating solution using a spinner, a flow coater, a roll coater or the like, followed by drying. The following are preferable examples of the organic solvent.

Water-soluble Organic Solvents with Boiling Point of 95 to 180° C. Among the organic solvents with a boiling point of 95 to 180° C., there are water-soluble solvents are known in the art including, for example, 1-propanol (bp=97° C.), dioxane (bp=101° C.), 2,2-dimethyl-1-propanol (bp=114° C.), trioxane (bp=115° C.), propargyl alcohol (bp=115° C.), 1-butanol (bp=118° C.), propylene glycol monomethyl ether (bp=120° C.), ethylene glycol diethyl ether (bp=121° C.), ethylene glycol monomethyl ether (bp=125° C.), propylene glycol monomethyl ether (bp=132° C.), N,N-dimethylethanolamine (bp=135° C.), ethylene glycol monoethyl ether (bp=136° C.), N-ethylmorpholine (bp=138° C.), 2-isopropoxyethanol (bp=139° C.), ethylene glycol monomethyl ether acetate (bp=145° C.), methyl lactate (bp=145° C.), ethylene glycol monoethyl ether acetate (bp=145° C.), ethyl lactate (bp=156° C.), diethylene glycol dimethyl ether (bp=160° C.), 3-methoxy-1-butanol (bp=160° C.), N,N-diethylethanolamine (bp=162° C.), 2-(methoxymethoxy)ethanol (bp=168° C.), diacetone alcohol (bp=168° C.), 2-butoxyethanol (bp=170° C.), frufuryl alcohol (bp=170° C.), 3-methoxy-3-methyl-1-butanol (bp=174° C.), tetrahydrofurfuryl alcohol (bp=178° C.), ε-caprolactum (bp=180° C.), and the like.

These may be used alone or in combinations of two or more, but not limited to the compounds described above. Furthermore, an organic solvent with a higher boiling point may be added as needed.

### Amount of Compounding Thermal Polymerization Inhibitor

A small amount of the thermal polymerization inhibitor is usually added to the crosslinkable monomer (B) to ensure thermal stability. The amount of compounding the thermal polymerization inhibitor in the pattern forming material according to this embodiment is preferably less than 1 part by mass, more preferably from 0.01 parts by mass to about 1 part by mass per 100 parts by mass of the total amount of the matrix polymer (A), the crosslinkable monomer (B), and the photopolymerization initiator (C).

The boiling point of the water-soluble organic solvent compounded in the pattern forming material according to this embodiment is limited to 95 to 180° C. because that rapid drying in the step for coating the pattern forming material is achieved, thereby resulting in the formation of striation when the boiling point of the solvent is lower than 95° C. On the other hand, when the boiling point of the solvent is higher than 180° C., the drying step requires a long period of time because of its slow drying property. A solvent with lower or higher boiling point may be added for adjusting the viscosity as long as the water-soluble organic solvent having a boiling point falling within this range is used as a principal component, and the coating properties are not deteriorated.

As the pattern forming material is developed with purified water-based developer having a pH of 6.5 or less, large amounts of the water-insoluble solvent included in the composition may cause precipitation in the developing step. Also for this reason, a water-soluble solvent is used. Other solvent may be added as long as no residue is left on the substrate.

The process for forming a noble metal pattern using the pattern forming material according to this embodiment will be explained below.

(A) First, the pattern forming material according to this embodiment with other additive component as needed is coated on, for example, a glass substrate and dried at a given temperature.

(B) Next, contact exposure or proximity exposure of dried film is carried out through a patterned mask, and developed with the purified water-based developer having a pH of less than 7, preferably 6.5 or less. Then the film is rinsed with the purified water-based developer followed by removal of the adhered water to form the pattern. The purified water-based developer refers to purified water obtained by ion exchange, distillation, filtration using a reverse osmosis membranes or the like. A purified water-based developer obtained by an ion exchange treatment is preferred because it does not inhibit the chemical absorption of the metal ions or the complex ion of the metal compound.

(C) Then the pattern is immersed in an aqueous solution of a noble metal compound to form an ionic bond (chemical absorption) of the noble metal ion or the noble metal complex ion in the aqueous solution with the carboxyl group or the sulfonate group in the pattern-forming material to produce the metal-containing pattern. Finally, the metal pattern or metal oxide pattern is produced by sintering the metal-containing pattern at 450 to 600° C. to burn off the organic matter.

The process for coating the pattern-forming material may be carried out using any one of a spin coater, a roll coater, a curtain flow coater, a spray coater, a dip coater, a bar coater, a table coater, and the like.

The light source for use in the exposure may be any one of an ultra high-pressure mercury lamp, chemical lamp, black light, arc lamp, and the like. A lamp for exposure with emission corresponding to the absorption wavelength of the initiator may be chosen. The light ray used for the exposure is preferably ultraviolet light.

The developing method may be any one of a spraying method, a dipping method and a showering method.

The metal compound to be absorbed to the pattern may be any water-soluble compound of a metal with a valency of two or more. Use of such a metal compound enables a reduction of the amount of waste metal and, therefore, the metal pattern can be formed at low cost.

Examples of the noble metal compound to form the aqueous solution include chloroplatinic acid, hexaammine platinum (IV) tetrachloride, dinitro diammine platinum (II) nitrate, tetraammine platinum dichloride, tetraammine platinum hydroxide, hexaammine platinum hydroxide, tetraammine palladium chloride, tetraammine palladium hydroxide, iridium chloride hydrate, rhodium chloride, rhodium nitrate, silver nitrate, silver cyanide, chlorauric acid, potassium cyanoaurate, potassium tetracyanoaurate (III), chlorauric acid, hexachloro iridium (IV) acid, and the like. These compounds may be used alone or in combinations of two or more. The noble metal compound to form an aqueous solution is not limited to the compounds described above, and also the concentration of the noble metal compound and the temperature of the aqueous solution are not limited.

To form the pattern with a constant metal film thickness, the chemical absorption of an appropriate amount of the metal ion is essential. To this end, the acid value of the solid content of the mixture including the matrix polymer (A), the crosslinkable monomer (B), and the photopolymerization initiator (C). The acid value falls in the range of preferably from 150 mgKOH/g to 350 mgKOH/g, more preferably from 220 mgKOH/g to 300 mgKOH/g. However, when the acid value is too high, the resistance against development deteriorates, which leads to the loss of the pattern during the development. As a result, the amount of chemically absorbed metal ion decreases. On the other hand, when the acid value is too low, the development using the purified water-based developer having a pH of 6.5 or less is disabled, and a large amount of residue is left on the developed pattern. The preferable range of the acid value of the matrix polymer (A) alone; that of the three components of the matrix polymer (A), the crosslinkable monomer (B), and the photopolymerization initiator (C); and that of the composition further including the solvent may vary because the number of components will differ.

Next, a preferable example of the preparation of the photosensitive material according to this embodiment will be explained as well as the results of the use thereof.

### EXAMPLES

The present invention will be explained in more detail with reference to Examples.

### Synthesis Example 1

### Preparation of Crosslinkable Monomer

A separable flask containing 202.2 g of N-methylolacrylamide and 1.0 g of 4-hydroxy-2,2,6,6-tetramethylpiperidine-N-oxyl, as a polymerization inhibitor was placed in an oil bath set to 88° C., and N-methylolacrylamide was melted with gentle stirring. A non-alcoholic solvent such as methyl ethyl ketone may be added to facilitate dissolution of N-methylolacrylamide.

After the solution became transparent, 90.77 g of pentaerythritol was added and the solution was stirred. When the temperature of the solution reached 86° C., dry air was introduced at a flow rate from 7 L/min to 8 L/min. Then 2.78 g of p-toluenesulfonic acid dissolved in 2.78 g of methanol was added over about 5 minutes and the reaction was allowed for 85 minutes.

After the reaction was completed, 689.7 g of propylene glycol monomethyl ether containing 4 ml of concentrated aqueous ammonia was added. The separable flask was then removed form the oil bath and cooled to room temperature. The liquid thus obtained was filtered through a filter paper No. 2.

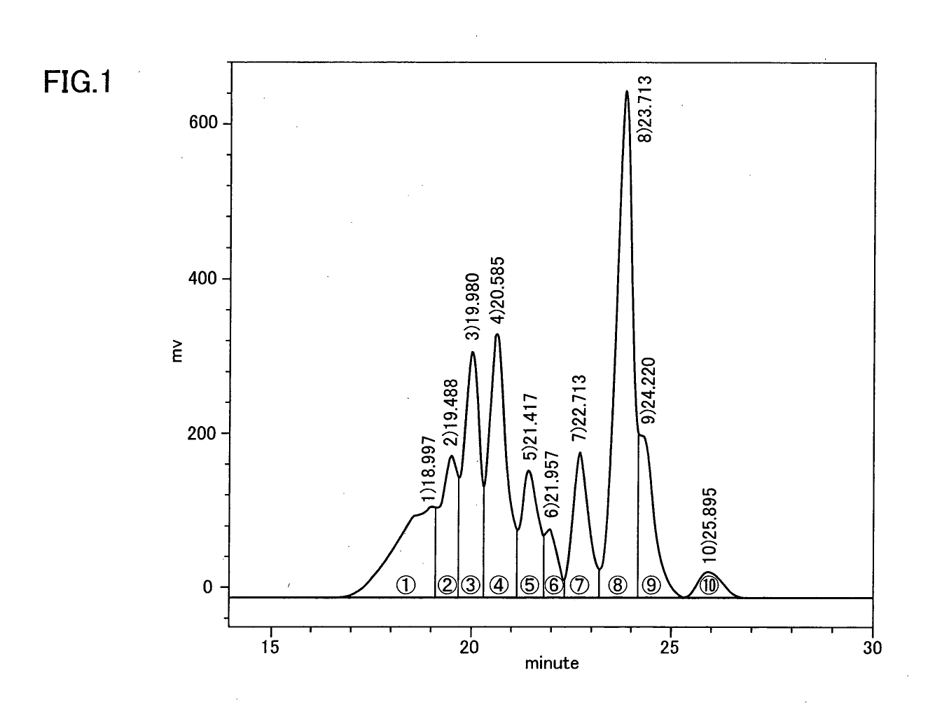

Identification of the product was carried out using a gel permeation chromatography and a mass spectrometer. The results are shown in FIG. 1 to 3. FIG. 1 shows the results of the gel permeation chromatography analysis (SHODEX GPC SYSTEM-1™, Showa Denko K. K.) of the product. the measurement conditions are as shown below. Results are shown in TABLE 1.

### Column: Shodex KF-G×1 (4.6 mm I. D.*10 mm)+KF-801×3 (8 mm I. D.*300 mm)

### Eluent: THF

### Flow Rate: 1.0 ml/min

### Sample Concentration: ca. 0.4%

### Preparation of Sample: Dissolved in the Eluent

### Injection: 20 μl

### Column Temperature: 40° C.

### Detection: UV 220 nm/RI

TABLE 1

| | Retention | Area | | | |
|---|---|---|---|---|---|
| Peak | Time ( [symbol] ) | (uv * sec) | Area % | Height (uv) | Height % |
| \textcircled{1} | 18.997 | 8208233 | 11.4044 | 119387 | 5.1428 |
| \textcircled{2} | 19.488 | 5063230 | 7.0348 | 185353 | 7.9844 |
| \textcircled{3} | 19.98 | 8875918 | 12.3321 | 319016 | 13.7422 |
| \textcircled{4} | 20.585 | 10723470 | 14.8991 | 342701 | 14.7625 |
| \textcircled{5} | 21.417 | 5113638 | 7.1048 | 167198 | 7.2023 |
| \textcircled{6} | 21.957 | 2049418 | 2.8474 | 89898 | 3.8725 |
| \textcircled{7} | 22.713 | 5235266 | 7.2738 | 191123 | 8.233 |
| \textcircled{8} | 23.713 | 19663540 | 27.3204 | 656654 | 28.2866 |
| \textcircled{9} | 24.22 | 5472151 | 7.603 | 214253 | 9.2294 |
| [symbol] | 25.895 | 1569095 | 2.1801 | 35848 | 1.5442 |
| | Total | 71973959 | | 2321432 | |

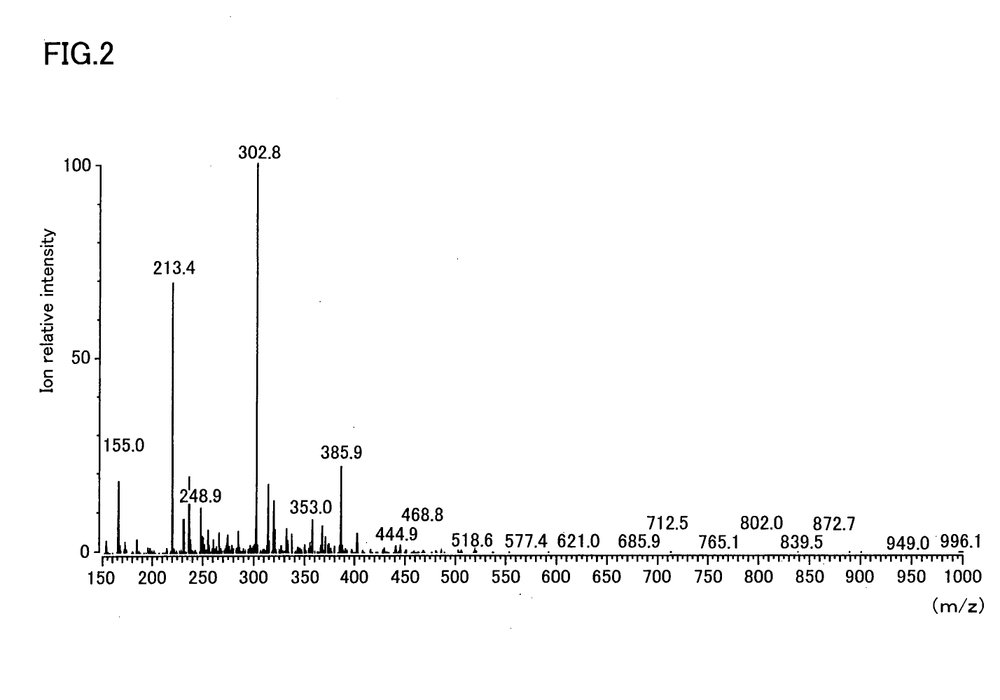

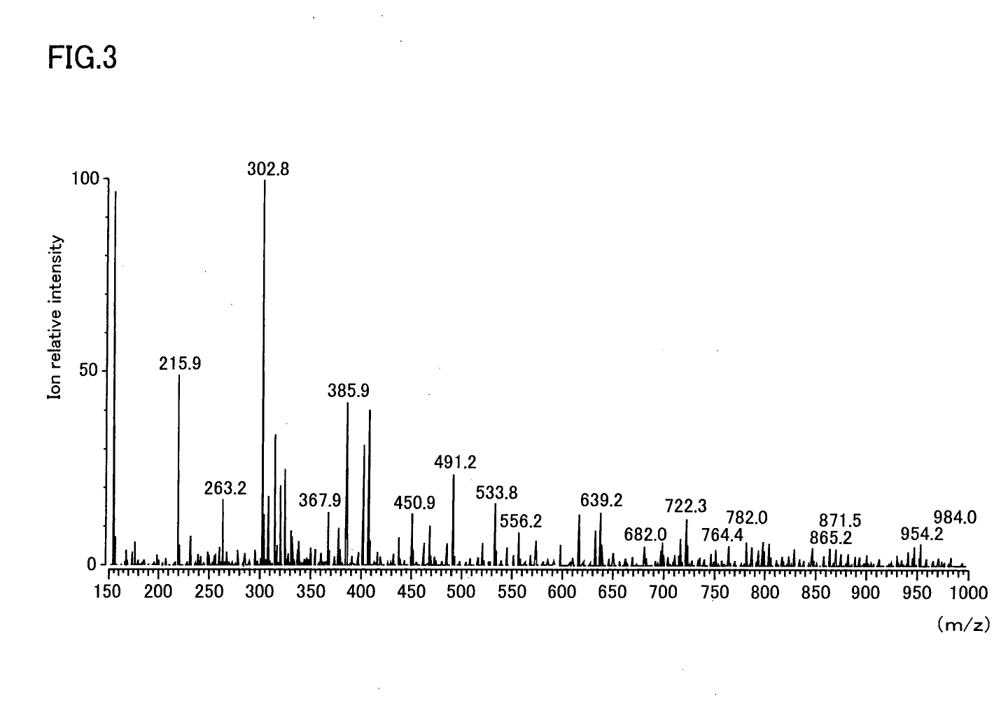

FIGS. 2 and 3 show the results of mass spectroscopic analysis (FINNIGAN LCQ DUO™, Thermo Quest) of the product. The measurement conditions are as shown below.

### Monomer Solution for Measurement: 600 ppm in methanol

### Gradient: CH₃OH/water (FA 0.1%)=70/30, iso 0.2 ml/min

### Ionization Method: APCI positive & ESI positive

The assignment of each chromatographic peak in FIG. 1 is shown in Table 2. In Table 2, PET represents pentaerythritol, DPET represents dipentaerythritol, and NMA represents N-methylolacrylamide. Moreover, “Condensation product of DPET with NMA×n (integer)” refers to the compound obtained by the condensation of one molecule of DEPT with n molecules of NMA.

TABLE 2

| Peak | |
|---|---|
| \textcircled{1} | Condensation product of DPET with NMA × 4 |
| | Condensation product of DPET with NMA × 5 |
| | Condensation product of DPET with NMA × 6 |
| \textcircled{2} | Condensation product of DPET with NMA × 4 |
| | Condensation product of DPET with NMA × 5 |
| | Condensation product of DPET with NMA × 6 |
| \textcircled{3} | Condensation product of PET with NMA × 2 |
| | Condensation product of PET with NMA × 3 |
| \textcircled{4} | Condensation product of DPET with NMA × 1 |
| \textcircled{5} | Condensation product of DPET with NMA × 1 |
| \textcircled{6} | — |
| \textcircled{7} | Etherbis-N-methyleneacrylamide |
| | {(CH2═CHCONHCH2)2—O} |
| \textcircled{8} | Methylenebisacrylamide |
| | {(CH2═CHCONH)2—CH2} |
| \textcircled{9} | — |

### Preparation Example 1

The metal pattern forming material with the composition as follows was prepared using the cross-liking monomer (the condensation product of pentaerythritol with N-methylolacrylamide) prepared as described in Synthesis Example 1.

### Composition 1

### (A) Glycidyl methacrylate-adduct of polyacrylic acid (acid value=420 mgKOH/g): 50 parts by mass

(b1) Crosslinkable monomer: 39 parts by mass
(b2) Polyethylene glycol diacrylate (n=6): 9 parts by mass
(C) Bis(2,4,6-trimethylbenzoyl)phenylphosphine oxide: 2 parts by mass

### Methylhydroquinone: 0.01 parts by mass

### Propylen glycol monomethyl ether (PGME) (bp=120° C.): 323 parts by mass

The acid value of the 23.64% PGME solution: 53 mgKOH/g

### Preparation Example 2

### Composition 2

### (A) Glycidyl methacrylate-adduct of polyacrylic acid (acid value=453 mgKOH/g): 50 parts by mass

(b1) Crosslinkable monomer: 39 parts by mass
(b2) Polyethylene glycol diacrylate (n=6): 9 parts by mass
(C) 2,4,6-trimethylbenzoyldiphenylphosphine oxide: 2 parts by mass

### Methylhydroquinone: 0.01 parts by mass

### Propylen glycol monomethyl ether (PGME) (bp=120° C.): 323 parts by mass

The acid value of the 23.64% PGME solution: 56.5 mgKOH/g

### Preparation Example 3

### Composition 3

(A) Glycidyl methacrylate-adduct of polyacrylic acid (acid value=595 mgKOH/g): 50 parts by mass

(b1) Crosslinkable monomer: 39 parts by mass
(b2) Polyethylene glycol diacrylate (n=6): 9 parts by mass
(C) 2,4,6-trimethylbenzoyldiphenylphosphine oxide: 2 parts by mass

### Methylhydroquinone: 0.01 parts by mass

### Solfit (3-methoxy-3-methyl-1-butanol) ((bp=174° C.): 323 parts by mass

The acid value of the 23.64% Solfit solution: 53 mgKOH/g

### Example 1

On a glass substrate of 10 cm square with a thickness of 1 mm, one drop of the Composition 1 as described above was spin coated using a spin-coater (manufactured by Mikasa Co., Ltd.) at 1500 rpm for 30 seconds, dried on a hot plate at 90° C. for 15 minutes. Exposure was carried out by irradiating the negative mask with a parallel ultraviolet ray exposure equipment at 300 mJ. The coated film was developed at a pressure of 0.5 MPa, pH=6.5, and with a water temperature of 25° C. for 120 seconds, blown with compressed air to remove water droplets, and dried on a hot plate for 15 minutes. The thickness of the coated film was 1.2 μm.

The undercut profile and the deteriorated developing properties were observed in Example 1, however the obtained pattern was usable.

The pattern was immersed in an aqueous solution of tetrakis(monoethanolamine)platinum complex (1 mass % of Pt) for 30 seconds, then blown again with compressed air to remove water droplets, and sintered. Sintering temperature was 550° C. and the sintering time was 60 minutes. As a result, dense platinum film was observed on the glass substrate.

### Example 2

An operation similar to that in Example 1 was carried out using the Composition 2. The pattern obtained exhibited excellent developing properties. As a result, a dense platinum film similar to in Example 1 was also obtained in this Example 2.

### Example 3

An operation similar to that in Example 1 was carried out using the Composition 3. The pattern obtained exhibited excellent developing properties. As a result, a dense platinum film similar to Example 1 was also observed in this Example 3.

### Comparative Example 1

A metal pattern was produced under the conditions similar to Example 1 except that an aqueous developer having a pH of 7.2 was used. Thus produced platinum film was insufficiently dense and inappropriate for use.

As apparent from these Examples and Comparative Example, the material and cost savings for forming a metal pattern can be achieved in which the metal pattern can be formed only on the necessary region of the pattern without using the expensive noble metal for unnecessary region. Also, a metal pattern with good quality can be provided because a metal film with a constant thickness may be formed as described above.

Typically, the development of the polymer containing a carboxyl group is carried out using an alkaline developer. In contrast, according to the process for forming the metal pattern of this embodiment, the development is carried out using the purified water-based developer having a pH of less than 7, preferably 6.5 or less. As described above, no alkaline component in the developer is ionically bound to the carboxyl group or the sulfonate group in the cross-linked pattern because no alkaline developer is employed. Consequently, the process has an advantage that the amount of the noble metal chemically absorbed in the following step for immersing is not deteriorated.

In the case of metal wirings in the form of metal patterns, various thickness may be required. According to the process using the photopolymerization initiator of the present invention, the pattern with the thickness of 0.1 μm to 1000 μm or even more can be formed. However, forming too thick pattern is not practical because it takes a long period of time for sintering. Typically, the patterned photosensitive layer is formed to have a thickness of 0.1 μm to 5 μm, preferably 0.5 μm to 2 μm. The amount of absorbed noble metal or noble metal compound may be controlled by the acid value of the composition of the pattern-forming material as well as the thickness thereof. Particularly, the present invention is advantageous in forming thin and dense metal pattern.

Notable improvement of the performances in the coating apparatus arising from the recent development in the technology of producing flat panel displays enables the control of the thickness of the coating with a high degree of accuracy, which also contributes to the present invention.

As described above, the process for forming the metal pattern according to this embodiment enables forming the dense noble metal pattern at low cost.

According to the process for forming the metal pattern of this embodiment, a metal pattern with good quality can be formed through a process for forming a noble metal pattern including a series of steps of: coating, drying, light irradiation through a mask, and development steps of the photosensitive material prepared from the polymer and monomers having a carboxyl group or a sulfonate group; a step for forming the metal-containing pattern by immersing the pattern in an aqueous solution of a cationic noble metal compound to allow it to be chemically absorbed to the pattern; and a step for sintering the metal-containing pattern. A photosensitive material can be found as the optimal pattern forming material used for this process for forming the metal pattern can be found.

1. A crosslinkable monomer used for forming a metal pattern material comprising: a condensation product of a polyhydric alcohol with N-methylol(meth)acrylamide.

2. A crosslinkable monomer according to claim 1, wherein the polyhydric alcohol is pentaerythritol.

3. A crosslinkable monomer according to claims 1 or 2, wherein the condensation product is a mixture of mono-condensate in which one molecule of the N-methylol(meth)acrylamide is condensed with one molecule of the pentaerythritol, di-condensate, tri-condensate, tetra-condensate, penta-condensate and hexa-condensate with respect to the pentaerythritol.

4. A crosslinkable monomer according to any one of claims 1 to 3 obtained by the dehydration reaction of the N-methylol(meth)acrylamide with a given amount of the pentaerythritol added thereto in the presence of an acid catalyst.

5. A crosslinkable monomer according to any one of claims 1 to 4, wherein further comprises a hindered amine-based polymerization inhibitor.

6. A process for forming a metal pattern comprising:
a pattern-forming step for forming a pattern by photolithography including an exposure step for carrying out exposure on a pattern forming material that can be developed with a purified water-based developer having a pH of less than 7 and that has at least one of a carboxyl group and a sulfonate group, and a development step for developing the exposed pattern formation material with the purified water-based developer having a pH of less than 7;
a metal-containing pattern-forming step for forming a metal-containing pattern by chemically absorbing a metal ion or a complex ion of a metal compound in an aqueous solution of metal components to the pattern; and
a metal pattern-forming step for forming a metal pattern containing at least one of the elemental metal or metal oxide by sintering the metal-containing pattern.

7. A process for forming a metal pattern according to claim 6, wherein the pattern forming material can be developed with a purified water-based developer having a pH of 6.5 or less and the exposed pattern formation material is developed with the purified water-based developer having a pH of 6.5 or less in the development step.

8. A process for forming a metal pattern according to claims 6 or 7, wherein the pattern forming material comprises (A) a matrix polymer, (B) a crosslinkable monomer and (C) a photopolymerization initiator, the matrix polymer (A) containing at least one of a carboxyl group and a sulfonate group.

9. A process for forming a metal pattern according to claim 8, wherein the acid value of the matrix polymer (A) is from 400 mgKOH/g to 700 mgKOH/g.

10. A process for forming a metal pattern according to claims 8 or 9, wherein the matrix polymer (A) has an addition reaction unit of the carboxyl group in the main chain, and glycidyl methacrylate.

11. A process for forming a metal pattern according to any one of claims 8 to 10, wherein the crosslinkable monomer (B) comprises: (b1) a multifunctional monomer obtained by the condensation of at least a polyhydric alcohol with N-methylol (meta)acrylamide; and (b2) a multifunctional (meth)acrylate.

12. A process for forming a metal pattern according to claim 11, wherein the amount of compounding of the multifunctional monomer (b1) is from 10 parts by mass to 50 parts by mass and the amount of compounding of the multifunctional (meth)acrylate (b2) is from 5 parts by mass to 23 parts by mass per 100 parts by mass of an overall solid content.

13. A metal pattern forming material comprising
(A) a matrix polymer;
(B) a crosslinkable monomer; and
(C) a photopolymerization initiator,
wherein the matrix polymer (A) containing at least one of a carboxyl group and a sulfonate group.

14. A metal pattern forming material according to claim 13, wherein the crosslinkable monomer (B) comprises:
(b1) a multifunctional monomer obtained by the condensation of at least a polyhydric alcohol with N-methylol (meta)acrylamide; and
(b2) a multifunctional (meth)acrylate, and the pattern forming material can be developed with a purified water-based developer having a pH of less than 7.
